(19) United States
(12) Patent Application Publication
(10) Pub. No.: US 2019/0346641 A1
(43) Pub. Date: Nov. 14, 2019

(54) HYBRID OPTICAL SUBASSEMBLY PACKAGE

(71) Applicant: Finisar Corporation, Sunnyvale, CA (US)

(72) Inventors: Norbert Schlepple, San Jose, CA (US); Matthew Tomes, Sunnyvale, CA (US)

(21) Appl. No.: 16/407,525

(22) Filed: May 9, 2019

Related U.S. Application Data
(60) Provisional application No. 62/669,360, filed on May 9, 2018.

(51) Int. Cl. G02B 6/42

(52) U.S. Cl. CPC G02B 6/4248; G02B 6/4256; G02B 6/422

(57) ABSTRACT

In an example, an optoelectronic device may include a hermetic cavity, an optical component, a multilayer ceramic, and an electrical circuit. The optical component may be positioned inside the hermetic cavity. The multilayer ceramic may define at least one side of the hermetic cavity. The electrical circuit may be routed through the multilayer ceramic to electrically couple the optical component positioned inside the hermetic cavity to an electrical component positioned outside of the hermetic cavity.

### CROSS-REFERENCE TO RELATED APPLICATION

This application claims the benefit of and priority to U.S. Provisional App. No. 62/669,360, filed on May 9, 2018. The 62/669,360 application is incorporated herein by reference

### FIELD

The application relates generally to a hybrid optical subassembly package.

### BACKGROUND

Unless otherwise indicated herein, the materials described herein are not prior art to the claims in the present application and are not admitted to be prior art by inclusion in this section.

Optoelectronic components may be used in the conversion of optical signals to electrical signals and/or the conversion of electrical signals to optical signals. In some cases, the optoelectronic components may be positioned inside or outside hermetic enclosures within the optoelectronic device.

The subject matter claimed herein is not limited to embodiments that solve any disadvantages or that operate only in environments such as those described above. Rather, this background is only provided to illustrate one example technology area where some embodiments described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Some embodiments described herein generally relate to a hybrid optical subassembly package, e.g., that may be implemented as or in one or more optoelectronic devices, modules, etc. In an example embodiment, an optoelectronic device may include a hermetic cavity and an optical component positioned inside the hermetic cavity. Additionally, the optoelectronic device may include a multilayer ceramic that defines at least one side of the hermetic cavity. The optoelectronic device may also include an electrical circuit routed through the multilayer ceramic to electrically couple the optical component positioned inside the hermetic cavity to an electrical component positioned outside of the hermetic cavity.

In another example embodiment, an optoelectronic module may include a housing that defines a housing cavity. Additionally, the optoelectronic module may include a multilayer ceramic at least partially positioned within the housing cavity. A hermetic cavity may be positioned within the housing cavity and may be defined on at least one side by the multilayer ceramic. Further, the optoelectronic module may include an optical component coupled to the multilayer ceramic and positioned inside the hermetic cavity. The optoelectronic module may also include an electrical component positioned outside the hermetic cavity and coupled to an opposite side of the multilayer ceramic as the optical component, in which the electrical component may be electrically coupled to the optical component through the multilayer ceramic.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a cross-sectional view of an example OSA of an example optoelectronic module,

FIG. 2 is a cross-sectional view of another example OSA and another example optoelectronic module, and

FIG. 3 is a cross-sectional view of another example OSA and another example optoelectronic module,

all arranged in accordance with at least one embodiment described herein.

### DESCRIPTION OF EMBODIMENTS

US Publication No. 2018/0156992, published on Jun. 7, 2018 (hereinafter the '992 publication), U.S. Publication No. 2017/0179680, published Jun. 22, 2017 (hereinafter the '680 publication), and U.S. Application Ser. No. 15/822,952 (hereinafter the '952 application) are incorporated herein by reference.

In some cases, optoelectronic elements may compete for space in high density configurations, such as configurations inside hermetic boxes. Space may become more limited in hermetic boxes as profiles of the hermetic boxes become smaller, as optoelectronic components are added inside the hermetic boxes, and/or as optoelectronic components inside the hermetic box have larger footprints. Additionally or alternatively, increasing integration of module-level functionality may become more difficult given some high density configurations of optoelectronic components that can create connectivity and/or communication difficulties and inefficiencies. For example, connectivity and/or communication difficulties and inefficiencies may arise when numerous (e.g., too many) optoelectronic components inside the hermetic box are necessarily coupled (electrically, thermally, or otherwise) to components outside the hermetic box.

In some embodiments, a hybrid optical subassembly (OSA) may include hermetic and non-hermetic elements. As described herein, the term “hermetic” is descriptive of a type of enclosure, namely, a sealed, airtight enclosure. Thus, a hermetic housing may define a sealed, airtight enclosure with a hermetic cavity therein. A hermetic element may be an element positioned inside the hermetic cavity, and a non-hermetic element may be an element positioned outside the hermetic cavity. In these or other embodiments, various components that have (in some applications) been a hermetic element, may be changed to a non-hermetic element, e.g., positioned outside the hermetic cavity. For example, integrated circuits (ICs), optical components (e.g., passive/active optical components), electrical components, and/or optoelectronic components may be moved from inside the hermetic cavity to outside the hermetic cavity.

By positioning elements from inside the hermetic cavity to outside the hermetic cavity, additional space may be made available within the hermetic cavity and/or the hermetic cavity may be configured to have a smaller/thinner profile than previously achievable. Additionally or alternatively, integration of non-hermetic elements with the hermetic housing may be more efficiently facilitated. Additionally or alternatively, positioning elements from inside the hermetic cavity to outside the hermetic cavity may help to facilitate larger components, consolidation of components, etc. (e.g., ICs, microcontroller units (MCUs), etc.) outside the hermetic cavity. Additionally or alternatively, positioning elements from inside the hermetic cavity to outside the hermetic cavity may help to facilitate the positioning of high temperature elements closer to a heat sink (e.g., high temperature ICs, resistive loads, etc.) to more effectively facilitate heat transfer between various elements and the heat sink. Additionally or alternatively, electrical routing between elements within the hermetic cavity and outside the hermetic cavity may be more efficiently facilitated.

Reference will now be made to the drawings to describe various aspects of example embodiments of the present disclosure. It is to be understood that the drawings are diagrammatic and schematic representations of such example embodiments, and are not limiting of the present invention, nor are they necessarily drawn to scale.

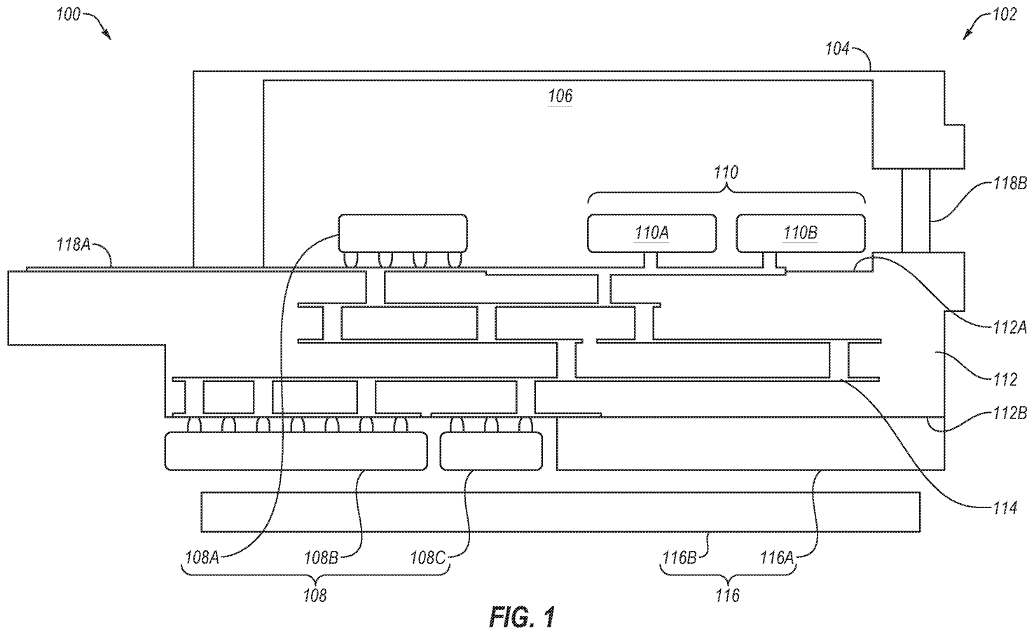

FIG. 1 is a cross-sectional view of an example OSA 100 of an example optoelectronic module 102, arranged in accordance with at least one embodiment described herein. As illustrated, the optoelectronic module 102 may include a hermetic housing 104, a hermetic cavity 106, electrical components 108A, 108B, 108C (generally “electrically components 108”), optical components 110A, 110B (generally “optical components 110”), a multilayer ceramic 112, an electrical circuit 114, one or more heat sinks 116A, 116B (generally “heatsinks 116”), and various inputs/outputs 118A, 118B to and from the hermetic cavity 106 (e.g., “RF in/out” 118A and “optical in/out” 118B in FIG. 1, electrical, and/or optical feed throughs, etc.).

In these or other embodiments, the hermetic cavity 106 may be at least partially defined by the hermetic housing 104. Additionally or alternatively, the hermetic cavity 106 may be at least partially defined by the multilayer ceramic 112 (e.g., by a first surface 112A of the multilayer ceramic). In general, one or more of the optical components 110 may be positioned inside the hermetic cavity 106. In the illustrated embodiment, two optical components 110 are positioned inside the hermetic cavity 106. Each of the optical components 110 may include, e.g., a laser, a photodiode, an optical IC (“OIC”), a photonic IC (“PIC”), or other suitable optical component. In some embodiments, each of the one or more optical components 110 may be coupled to the first surface 112A of the multilayer ceramic 112.

Additionally or alternatively, one or more of the electrical components 108 may be positioned inside the hermetic cavity 106. In the illustrated embodiment, one of the electrical components 108, e.g., the electrical component 108A, is positioned inside the hermetic cavity 106, while two of the electrical components 108, e.g., the electrical components 108B, 108C, are positioned outside the hermetic cavity 106. Each of the electrical components 108 may include, e.g., a driver, a transimpedance amplifier (TIA), a microcontroller (or microcontroller unit (MCU)), an electrical IC, a clock and data recover) (CDR) circuit, a transmitter chip, a receiver chip, and/or a transceiver chip. In some embodiments, each of the electrical components 108 positioned inside the hermetic cavity 106 may be coupled to the first surface 112A of the multilayer ceramic 112.

In these or other embodiments, the electrical component 108A may include a driver to convert an electrical data signal into a signal suitable to drive a light source, such as the optical component 110A implemented as a laser, to emit an optical signal that includes a data signal.

In some embodiments, the electrical component 108A may include a TIA and/or a limiting impedance amplifier (LIA). When implemented as a TIA or a LIA, the electrical component 108A may include data pins/pads that can receive/transmit the electrical data signals to/from a host device/system and connecting pads that can connect to one or more optical components, e.g., connecting pins/pads that connect to a corresponding one of the optical components 110A, e.g., implemented as light sources or photo detectors.

In some embodiments, electronic and/or radio frequency signal transmission lines, such as the RF in/out 118A in FIG. 1, may communicatively couple one or more of the electrical components 108, optical components 110, and/or other components of the optoelectronic module 102.

In some embodiments, the optical component 110A, when implemented as a laser, may include a fabry-perot (FP) laser, a distributed feedback (DFB) laser, a distributed Bragg reflector (DBR) laser, a vertical cavity surface emitting laser (VCSEL), or other suitable laser. The optical component 110B, when implemented as a PIC, may in general include a substrate with one or more layers formed above and/or on the substrate and having one or more waveguides, multiplexers, modulators, detectors, demultiplexers, optical amplifiers, and/or other components formed therein.

In some embodiments, hermetic elements inside the hermetic cavity 106 may be integrated with non-hermetic elements outside the hermetic cavity 106 via the electrical circuit 114. For example, the electrical circuit 114 may be routed through the multilayer ceramic 112 to electrically couple one or more of the optical components 110 inside the hermetic cavity 106 to one or more of the electrical components 108 (e.g., the electrical components 108B, 108C respectively implemented as a MCU and an electrical IC) positioned outside the hermetic cavity 106. Additionally or alternatively, the electrical circuit 114 may electrically couple one or more of the electrical components 108 (e.g., the electrical component 108A implemented as a driver or TIA) positioned inside the hermetic cavity 106 to one or more of the optical components 110 (e.g., the optical components 110A, 110B respectively implemented as a laser and a PIC) that are also positioned inside the hermetic cavity 106. Additionally or alternatively, the electrical circuit 114 may electrically couple one or more of the electrical components 108 positioned inside the hermetic cavity 106 to one or more of the electrical components 108 positioned outside the hermetic cavity 106. In these or other embodiments, the electrical circuit 114 may also thermally couple one or more of the electrical components 108 and/or optical components 110 to a corresponding one of the heat sinks 116, such as a local heat sink 116A or a global heat sink 116B. For example, heat transfer from one or more of the electrical components 108 and/or optical components 110 to the local heat sink 116A may occur through and/or be facilitated by the electrical circuit 114 such that a respective temperature of one or more of the electrical components 108 and/or optical components 110 may be lowered. In these and other embodiments, the multilayer ceramic 112 may be thermally insulative such that the electrical circuit 114 may function to transfer thermal energy generated by one or more components within the hermetic cavity 106 through the multilayer ceramic 112.

In some embodiments, the routing of the electrical circuit 114 through the multilayer ceramic 112 may be randomized, optimized (e.g. for thermal energy dissipation, manufacturing processes, etc.), distributed throughout the multilayer ceramic 112, step-like, etc. In some embodiments, the electrical circuit 112 may include one or more materials that have material properties conducive to electrical and thermal conductivity (e.g., copper, silver, aluminum, tungsten, nickel, gold, etc.). The electrical circuit 112 may include one or more thermally and/or electrically conductive vias, traces, and/or planes formed in and/or through the multilayer ceramic 112.

In some embodiments, the multilayer ceramic 112 may include ceramic materials such as alumina (e.g., aluminum oxide), aluminum nitride, and/or another suitable ceramic material. The multilayer ceramic 112 may include a thickness ranging from about 0.01 mm to about 0.05 mm, in other embodiments about 0.05 mm to about 0.1 mm, and in other embodiments about 0.1 mm to about 1 mm, the thickness being a distance measured between the first surface 112A of the multilayer ceramic and a second surface 112B of the multilayer ceramic that is opposite the first surface 112A as illustrated in FIG. 1. The thickness of the multilayer ceramic 112 may vary. For example, a portion of the multilayer ceramic 112 disposed between opposing non-hermetic elements may have a smaller thickness compared to a different portion of the multilayer ceramic 112 that is disposed between opposing hermetic elements and non-hermetic elements. Alternatively, the thickness of the multilayer ceramic 112 may be the same or similar throughout the optoelectronic module 102. In some embodiments, elements opposite of the electrical component 108A and the optical components 110 may include the electrical components 108B, 108C and the local heat sink 116A. The electrical components 108B, 108C and the local heat sink 116A may be coupled to the second surface 112B of the multilayer ceramic 112 opposite the first surface 112A of the multilayer ceramic 112. In these or other embodiments, a total thickness measured between the second surface 112A of the multilayer ceramic 112 and the hermetic housing 104 opposite the second surface may range from about 1 mm to about 3 mm, in other embodiments about 3 mm to about 5 mm, and in other embodiments about 5 mm to about 9 mm.

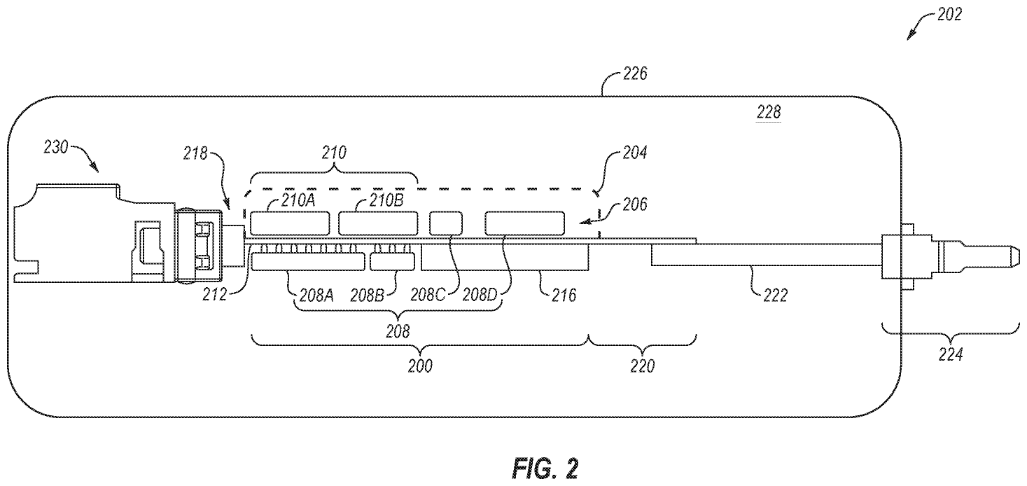

FIG. 2 is a cross-sectional view of another example OSA 200 and another example optoelectronic module 202, arranged in accordance with at least one embodiment described herein. As illustrated, the optoelectronic module 202 may include the OSA 200, a hermetic housing 204, a hermetic cavity 206, electrical components 208A, 208B, 208C, 208D (generally “electrical components 208”), optical components 210A, 210B (generally “optical components 210”), a multilayer ceramic 212, an electrical circuit (not shown), one or more heat sinks 216, various inputs/outputs to and from the hermetic cavity 206 (e.g., “RF in/out” not shown, “optical in/out” 218, electrical and/or optical feed throughs, etc.), a flex connection 220, a printed circuit board (PCB) 222, an edge connector 224, a module housing 226, a housing cavity 228, and one or more fiber ports 230. The fiber ports 230 may be configured to receive a fiber end connector coupled to an optical fiber to communicatively couple the optical fiber through the optical in/out to one or more of the optical components 210. One or more of the OSA 200, the optoelectronic module 202, the hermetic housing 204, the hermetic cavity 206, the electrical components 208, the optical components 210, the multilayer ceramic 212, the electrical circuit (not shown), the one or more heat sinks 216, and the various inputs/outputs to and from the hermetic cavity 206 may be the same as or similar to the respective elements described above with respect to FIG. 1.

In some embodiments, the electrical components 208 may also include an electrical integrated circuit (EIC). The EIC, like any other electrical and optical component described herein such as an OIC, may be positioned inside or outside of the hermetic cavity 206. The EIC may include a driver, bias circuitry, and/or other elements to drive the laser to emit an optical beam. In some embodiments, the optoelectronic module housing 226 may define the housing cavity 228 within which one or more of the elements described herein are positioned.

In some embodiments, the flex connection 220 may include hybrid or rigid flex circuitry for communicatively coupling the PCB 222 to the OSA 204 as described in greater detail in the '952 application. For example, the flex connection 220 may be bonded, soldered, or otherwise coupled to the electrical circuit of the multilayer ceramic 212 and/or the RF in/out lines. In some embodiments, the PCB 222 may include a FR4 (Flame Retardant 4) substrate and may include various electrical connections, traces, tracks, pads, and components for communicating signals to/from a host device/system via the edge connector 224. In some embodiments, the edge connector 224 may be configured to connect the optoelectronic module 202 as shown in FIG. 2 to the host device/system. For example, the edge connector 224 may include a standardized arrangement of pins with some of the pins used for high speed data transmission, while other pins may be used for low speed data communication and other pins may be used for status and control.

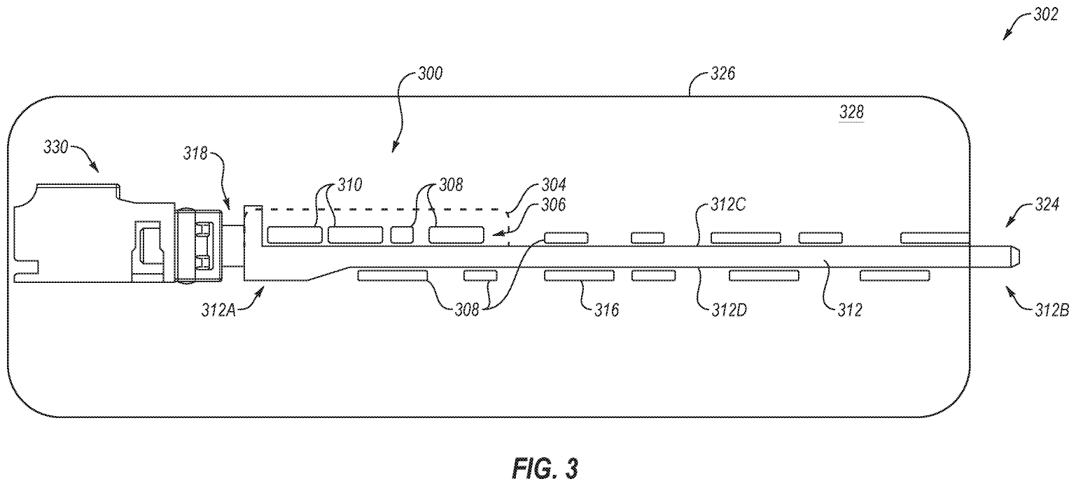

FIG. 3 is a cross-sectional view of another example OSA 300 and another example optoelectronic module 302, arranged in accordance with at least one embodiment described herein. As illustrated, the optoelectronic module 302 may include the OSA 300, a hermetic housing 304, a hermetic cavity 306, electrical components 308, optical components 310, a multilayer ceramic 312, an electrical circuit (not shown), one or more heat sinks 316, various inputs/outputs to and from the hermetic cavity 306 (e.g., “RF in/out” not shown, “optical in/out” 318, electrical and/or optical feed throughs, etc.), an edge connector 324, a module housing 326, a housing cavity 328, and one or more fiber ports 330. One or more of the OSA 300, the optoelectronic module 302, the hermetic housing 304, the hermetic cavity 306, the electrical components 308, the optical components 310, the multilayer ceramic 312, the electrical circuit (not shown), the one or more heat sinks 316, the various inputs/outputs to and from the hermetic cavity 306, the edge connector 324, the module housing 326, the housing cavity 328, and the fiber ports 330 may be the same as or similar to the respective elements described above with respect to FIGS. 1 and 2.

In these or other embodiments, the multilayer ceramic 312 may form a single, continuous piece from a first end 312A at or near which the hermetic cavity 306 is positioned to a second end 312B at or near the edge connector 324. The first end 312A may be opposite from the second end 312B. The multilayer ceramic 312 of FIG. 3 may replace the flex connection 220 and/or the PCB 222 of FIG. 2. Various electrical components 308 (only some of which are labeled for simplicity) and/or heat sinks 316 (only some of which are labeled for simplicity) may be positioned on one or both of a first surface 312C of the multilayer ceramic 312 and a second surface 312D of the multilayer ceramic 312. Additionally or alternatively, the optoelectronic module 302 may include multiple hermetic cavities like the hermetic cavity 306, although only one hermetic cavity 306 is illustrated in FIG. 3, with one or more optical components 310 positioned within each of the hermetic cavities along the multilayer ceramic 312 as needed.

Modifications, additions, or omissions may be made to the described embodiments of the present disclosure without departing from the scope of the present disclosure. For example, various embodiments have been described herein as including or being implemented with electrical and/or optical components such as ICs of an electrical/optical nature, electrical/optical feed throughs into and out of the hermetic cavity, etc. However, these are specific examples. In these or other embodiments, one or more of the electrical and/or optical components may include similar or comparable structures, implementations, positioning, etc. Additionally or alternatively, different components may be used or included than those specifically described.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner. Additionally, the terms “about” and “approximately” should be interpreted to mean 10% of actual value.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. An optoelectronic device comprising:
a hermetic cavity;
an optical component positioned inside the hermetic cavity;
a multilayer ceramic that defines at least one side of the hermetic cavity; and
an electrical circuit routed through the multilayer ceramic to electrically couple the optical component positioned inside the hermetic cavity to an electrical component positioned outside of the hermetic cavity.

2. The optoelectronic device of claim 1, wherein the optical component is positioned on a first surface of the multilayer ceramic and the electrical component is positioned on a second surface of the multilayer ceramic that is opposite the first surface.

3. The optoelectronic device of claim 1, further comprising:
a printed circuit board (PCB) positioned in a cavity defined by a housing of the optoelectronic device; and
a flex connection that electrically couples the PCB to one or more of the optical component, the multilayer ceramic, and the electrical component.

4. The optoelectronic device of claim 1, wherein the optical component includes a laser or a photodiode (PD).

5. The optoelectronic device of claim 1, further comprising a heat sink attached to the multilayer ceramic and thermally coupled to the optical component through the multilayer ceramic.

6. The optoelectronic device of claim 5, wherein the optical component is positioned on a first surface of the multilayer ceramic and the heat sink is positioned on a second surface of the multilayer ceramic that is opposite the first surface.

7. The optoelectronic device of claim 5, wherein the electrical circuit comprises thermally conductive material, the electrical circuit configured to thermally couple the optical component to the heat sink through the multilayer ceramic.

8. The optoelectronic device of claim 1, wherein the electrical component includes one or both of an integrated circuit (IC) and a microcontroller unit (MCU).

9. The optoelectronic device of claim 1, further comprising a second electrical component, wherein:
the optical component is positioned on a first surface of the multilayer ceramic;
the electrical component is positioned on a second surface of the multilayer ceramic opposite the first surface; and
the second electrical component is positioned on either the first surface or the second surface.

10. The optoelectronic device of claim 9, wherein the multilayer ceramic includes a first end at or near which the hermetic cavity is positioned and a second end opposite the first end, the multilayer ceramic further comprising an edge connector at or near the second end.

11. An optoelectronic module comprising:
a housing that defines a housing cavity;
a multilayer ceramic at least partially positioned within the housing cavity;
a hermetic cavity positioned within the housing cavity and defined on at least one side by the multilayer ceramic;
an optical component coupled to the multilayer ceramic and positioned inside the hermetic cavity; and
an electrical component positioned outside the hermetic cavity and coupled to an opposite surface of the multilayer ceramic as the optical component, the electrical component electrically coupled to the optical component through the multilayer ceramic.

12. The optoelectronic module of claim 11, wherein the multilayer ceramic includes a first end at or near which the hermetic cavity is positioned and a second end opposite the first end, the multilayer ceramic further comprising an edge connector at or near the second end.

13. The optoelectronic module of claim 12, wherein the edge connector of the multilayer ceramic comprises a plurality of electrical connections, the edge connector configured to electrically couple the optoelectronic module through the plurality of electrical connections to a host device.

14. The optoelectronic module of claim 11, wherein the optoelectronic module is devoid of a printed circuit board (PCB).

15. The optoelectronic module of claim 11, wherein the optical component includes a laser or a photodiode (PD).

16. The optoelectronic module of claim 11, further comprising a heat sink attached to the multilayer ceramic spaced apart from the optical component and thermally coupled to the optical component through the multilayer ceramic.

17. The optoelectronic module of claim 16, wherein the optical component is positioned on a first surface of the multilayer ceramic and the heat sink is positioned on a second surface of the multilayer ceramic that is opposite the first surface.

18. The optoelectronic module of claim 16, wherein:
the electrical circuit comprises thermally conductive material, the electrical circuit configured to thermally couple the optical component to the heat sink through the multilayer ceramic; and
the electrical component includes one or both of an integrated circuit (IC) and a microcontroller unit (MCU).

19. The optoelectronic module of claim 11, further comprising a second electrical component, wherein:
the optical component is positioned on the first surface of the multilayer ceramic;
the electrical component is positioned on a second surface of the multilayer ceramic opposite the first surface; and
the second electrical component is positioned on either the first surface or the second surface.

20. The optoelectronic module of claim 11, further comprising another electrical component positioned inside the hermetic cavity and coupled to a first surface of the multilayer ceramic, the optical component also coupled to the first surface of the multilayer ceramic.
